(19) United States
(12) Patent Application Publication
(10) Pub. No.: US 2025/0340090 A1
(43) Pub. Date: Nov. 6, 2025

(54) DOCKING APPARATUS AND AUTONOMOUS MOBILE APPARATUS INCLUDING SAME

(71) Applicants: Hyundai Motor Company, Seoul (KR); Kia Corporation, Seoul (KR)

(72) Inventors: Jin Ho HWANG, Cheonan-Si (KR); Sang Ah KO, Seoul (KR); Sang Heon LEE, Seoul (KR); Han Bee JEONG, Yongin-Si (KR); Sun Woo LEE, Seoul (KR)

(73) Assignees: Hyundai Motor Company, Seoul (KR); Kia Corporation, Seoul (KR)

(21) Appl. No.: 18/931,438

(22) Filed: Oct. 30, 2024

(30) Foreign Application Priority Data
May 3, 2024 (KR) 10-2024-0059345

(51) Int. Cl. B60D 1/24; B60D 1/01; B60D 1/36

(52) U.S. Cl. CPC B60D 1/246; B60D 1/01; B60D 1/36

(57) ABSTRACT

A docking device for docking an autonomous mobile device maintains a robust docked state by combining a magnetic fixation and a physical contact fixation. Furthermore, looseness is prevented from occurring while the autonomous mobile device is docked, and the contact portions of two portions are sealed to prevent the occurrence of a gap during docking.

### CROSS-REFERENCE TO RELATED APPLICATION(S)

The present application claims priority to Korean Patent Application No. 10-2024-0059345, filed on May 3, 2024, the entire contents of which is incorporated herein for all purposes by this reference.

### BACKGROUND OF THE PRESENT DISCLOSURE

### Field of the Present Disclosure

The present disclosure relates to a docking device and an autonomous mobile device including the same, wherein the docking device enables different autonomous mobile devices to maintain a robust connection when docked, and enables each autonomous mobile device to be stably docked in various directions.

### Description of Related art

Recently, there has been a growing interest in autonomous mobile devices. An autonomous mobile device is a device provided with autonomous driving technology that enables the device to move by itself even when a user or passenger does not directly control whether to move the device, a movement direction, a movement speed, etc. For example, autonomous vehicles, autonomous mobile robots, robotic vacuum cleaners, etc. are examples of autonomous mobile devices, and the autonomous mobile devices may be used for a variety of purposes.

As the purposes for using autonomous mobility devices diversify, systems for docking between autonomous mobile devices are also being developed.

For example, autonomous mobile devices may individually provide internal spaces, and multiple autonomous mobile devices may be docked together to expand the internal spaces depending on the intended use.

After autonomous mobile devices are docked, the docked state may be maintained. However, a fixing device for docking may become loose or docking may be released due to separation of the fixing device, resulting in damage to the autonomous mobility device and injury to a user due to the separation of the autonomous mobility devices.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to ensuring that a docking device for docking an autonomous mobile device maintains a robust docked state through a combination of magnetic fixation and physical contact fixation.

Furthermore, an aspect of the present disclosure is to provide a docking device and an autonomous mobile device including the same, wherein looseness is prevented from occurring while the autonomous mobile device is docked, and the contact portions of two parts are sealed to prevent a gap during docking.

To achieve the above aspect, a docking device according to an exemplary embodiment of the present disclosure, may include: an armature disposed in a first portion of the docking apparatus and including a claw; a first locking portion disposed in a second portion of the docking apparatus and fixed to the armature by forming a magnetic field when in contact with the armature; and a second locking portion rotatably disposed in the second portion and fixed to the claw by a change in rotation position depending on a rotation angle thereof, wherein when the first portion is connected to the second portion, the first portion is docked with the second portion by the formation of the magnetic field in the first locking portion and engagement of the second locking portion with the claw.

A first installation groove portion including the armature embedded therein may be formed in the first portion, a second installation groove portion is formed in the second portion, the second installation groove portion may be provided with a pole portion extending to be insertable into the first installation groove portion, and the first locking portion and the second locking portion may be provided in the pole portion.

The pole portion may be formed to include a space therein, the first locking portion and the second locking portion may be disposed from inside to outside, and the armature may be disposed to allow the claw to be inserted into the pole portion.

The second portion may further include a driving portion, and the first locking portion and the second locking portion may be connected to the armature by the driving portion.

The driving portion may include: a motor portion including a shaft configured to be rotated by a rotation force; a driving gear connected to the shaft; a first driven gear meshed with the driving gear and connected to the first locking portion; and a second driven gear meshed with the driving gear and connected to the second locking portion.

The first locking portion may include a first magnet portion and a second magnet portion, the first magnet portion may be rotatably disposed in the pole portion and connected to the first driven gear, and the second magnet portion may be spaced apart from the first magnet portion and fixed to the pole portion.

The first magnet portion and the second magnet portion may be formed of permanent magnets, and magnetic polarity of a magnetic field may change depending on a rotation position of the first magnet portion.

The second locking portion may include a cross-section formed in a semicircular shape, an insertion groove may be formed between a first end portion and a second end portion of the claw of the armature, and second end portion may be bent toward the insertion groove.

A fastening groove may be formed on an internal surface of the first installation groove portion in the first portion, and the driving portion may further include a moving member configured to be selectively inserted into the fastening groove by linearly moving in conjunction with rotation of the shaft.

The driving portion may further include a cam portion and including a protruding section on a circumferential surface thereof and connected to the shaft to be rotated, and the protruding section of the cam portion may be configured to be matched with the moving member when the first locking portion and the second locking portion are connected to the armature by operation of the driving portion.

A pair of moving members may be disposed and spaced apart from each other in the direction of linear movement, and the pairs of moving members may be connected via an elastic member.

A sealing member may be further provided to seal around the first installation groove portion and the second installation groove portion when the first portion is connected to the second portion.

In an autonomous mobile device including a docking device and including a body and a driving module, each body may include a first portion or a second portion for docking, the first portion may include an armature including a claw, and the second portion may include a first locking portion fixed to the armature by forming a magnetic field when in contact with the armature, and a second locking portion rotatably disposed and engaged with the claw by a change in rotation position depending on a rotation angle thereof, whereby when different bodies are connected to each other, the first portion may be docked with the second portion by the formation of the magnetic field in the first locking portion and the engagement of the second locking portion with the claw.

The second portion may include a pole portion in which the first locking portion and the second locking portion are disposed, and a driving portion configured to selectively connect the first locking portion and the second locking portion to the armature, and the driving portion may include a motor portion including a shaft configured to be rotated by a rotation force, a driving gear connected to the shaft, a first driven gear meshed with the driving gear and connected to the first locking portion, and a second driven gear meshed with the driving gear and connected to the second locking portion.

The first locking portion may include a first magnet portion and a second magnet portion, the first magnet portion may be rotatably disposed in the pole portion and connected to the first driven gear, and the second magnet portion may be spaced apart from the first magnet portion and fixed to the pole portion.

The second locking portion may include a cross-section formed in a semicircular shape and include a rotation center point connected to the second driven gear, an insertion groove may be formed between a first end portion and a second end portion of the claw of the armature, and the other end portion may be bent toward the insertion groove.

The body may further include an additional portion and a corresponding portion for docking at positions different from the first portion and the second portion, the additional portion may include the same armature as the first portion, and the corresponding portion may include the same first locking portion and second locking portion as the second portion, enabling the different bodies to be docked in a direction different from a docking direction of the first portion and the second portion through docking of the additional portion and the corresponding portion.

The additional portion may include a pole portion in which the first locking portion and the second locking portion are disposed, and a driving portion configured to selectively connect the first locking portion and the second locking portion to the armature, and the pole portion and the driving portion may be configured to be withdrawable or insertable, so that when positioned to be matched with the armature, the pole portion and the driving portion are withdrawn, and then the first locking portion and the second locking portion are fixed to the armature by the driving portion.

One of the additional portion and the corresponding portion may include a guide rail, and the other may include a roller configured to be inserted into and moved along the guide rail.

In the docking device including the structure as described above and the autonomous mobile device including the same, the docking device for docking the autonomous mobile device maintains a robust docked state through a combination of magnetic fixation and physical contact fixation.

Furthermore, the occurrence of looseness may be prevented while the autonomous mobile device is docked, and contact portions of two portions may be sealed, preventing gaps from occurring during docking.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 illustrates a docking device according to an exemplary embodiment of the present disclosure;

FIG. 2 illustrates a first portion in the docking device shown in FIG. 1;

FIG. 3 illustrates a second portion in the docking device illustrated in FIG. 1;

FIG. 4 illustrates a driving portion of the docking device illustrated in FIG. 1;

FIG. 5 illustrates a pre-locking state of the docking device illustrated in FIG. 1;

FIG. 6 illustrates a locking-in-progress state of the docking device illustrated in FIG. 1;

FIG. 7 illustrates a completed locking state of the docking device illustrated in FIG. 1;

FIG. 8 illustrates an autonomous mobile device according to an exemplary embodiment of the present disclosure;

FIG. 9 illustrates an exemplary embodiment of docking using multiple autonomous mobile devices according to an exemplary embodiment of the present disclosure;

FIG. 10 illustrates the docking of an additional portion and a corresponding portion in FIG. 9; and

FIG. 11 illustrates a guide rail and a roller according to the connection of the additional portion and the corresponding portion in FIG. 9.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, various exemplary embodiments set forth herein will be described in detail with reference to the accompanying drawings, and the same or similar elements are provided the same and similar reference numerals regardless of figure numbers, so duplicate descriptions thereof will be omitted.

The terms “module” and “unit” used for the elements in the following description are provided or interchangeably used in consideration of only the ease of writing the specification, and do not have distinct meanings or roles by themselves.

In describing the exemplary embodiments set forth herein, a detailed description of known functions or configurations incorporated herein will be omitted when it is determined that the description may make the subject matter of the present disclosure unnecessarily unclear. Furthermore, it should be appreciated that the accompanying drawings are provided only for the sake of easy understanding of the exemplary embodiments set forth herein, and the technical idea of the present disclosure is not limited to the accompanying drawings and includes all modifications, equivalents, or alternatives falling within the spirit and scope of the present disclosure.

Terms including an ordinal number such as “a first” and “a second” may be used to describe various elements, but the elements are not limited to the terms. The above terms are used merely for distinguishing one element from other elements.

In the case where an element is referred to as being “connected” or “coupled” to any other elements, it should be understood that not only the element may be directly connected or coupled to the other elements, but also another element may exist therebetween. Contrarily, in the case where an element is referred to as being “directly connected” or “directly coupled” to any other element, it should be understood that no other element exists therebetween.

A singular expression may include a plural expression unless they are definitely different in a context.

As used herein, the expression “comprise”, “include” or “have” are intended to specify the existence of mentioned features, numbers, steps, operations, elements, components, or combinations thereof, and should be construed as not precluding the possible existence or addition of one or more other features, numbers, steps, operations, elements, components, or combinations thereof.

A controller may include a communication device configured to communicate with a sensor or another control unit, a memory configured to store an operation system, a logic command, or input/output information, and at least one processor configured to perform determination, calculation, decision or the like which are required for responsible function controlling.

Hereinafter, a docking device and an autonomous mobile device including the same, according to an exemplary embodiment of the present disclosure, will be described with reference to the accompanying drawings.

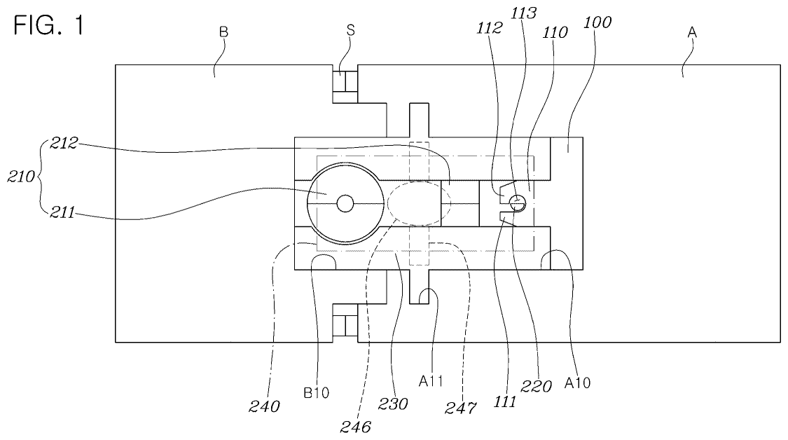

As illustrated in FIGS. 1 to 7, a docking device according to an exemplary embodiment of the present disclosure includes: an armature 100 disposed in a first portion A and including a claw 110; a first locking portion 210 disposed in a second portion B and configured to be fixed to the armature 100 by forming a magnetic field when in contact with the armature 100; and a second locking portion 220 rotatably disposed in the second portion B and configured to be fixed to the claw 110 by a change in rotation position depending on a rotation angle thereof.

The first portion A and the second portion B may be portions of components or mobile devices which is to be docked with each other.

The first portion A is provided with an armature 100, and the armature 100 includes the claw 110 formed to enable engagement connection.

The second portion B is provided with the first locking portion 210 and the second locking portion 220.

The first locking portion 210 is configured to be fixed to the armature 100 by the formation of a magnetic field when in contact with the armature 100, and may be formed of a permanent magnet or an electromagnet.

The second locking portion 220 may be configured to be engaged/connected to the claw 110 depending on a rotation position thereof while matched with the claw 110 of the armature 100.

In the present way, when connecting the first portion A and the second portion B, the first locking portion 210 and the second locking portion 220 may be fixed to the armature 100 by the formation of a magnetic field in the first locking portion 210 and the engagement of the second locking portion 220 with the claw 110, enabling the first portion A and the second portion B to achieve a docked state.

In the present way, through the fixation achieved by the formation of the magnetic field in the first locking portion 210 and the physical fixation of the second locking portion 220, the connection state between the first portion A and the second portion B during docking may be maintained robustly.

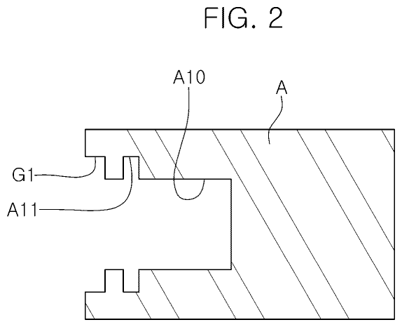

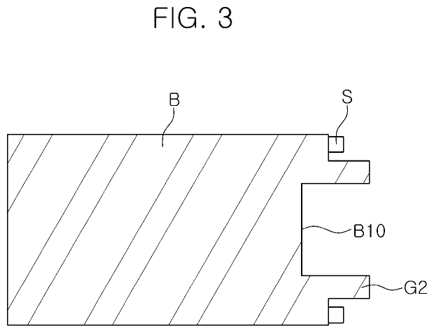

As illustrated in FIG. 1, FIG. 2, and FIG. 3, a first installation groove portion A10 including the armature 100 embedded therein is formed in the first portion A, and a second installation groove portion B10 is formed in the second portion B, the second installation groove portion B10 is provided with a pole portion 230 extending for insertion into the first installation groove portion A10, and the first locking portion 210 and the second locking portion 220 may be provided in the pole portion 230.

During docking of the first portion A and the second portion B, the first installation groove portion A10 and the second installation groove portion B10 may be matched with each other, and the pole portion 230 provided in the second installation groove portion B10 is inserted into the first installation groove portion A10. Accordingly, the first portion A and the second portion B may be fixedly positioned via the pole portion 230.

Here, the first locking portion 210 and the second locking portion 220 are provided in the pole portion 230, so that when the pole portion 230 is inserted into the first installation groove portion A10 and is in contact with the armature 100, the pole portion 230 is attached to the armature 100 by the formation of a magnetic field of the first locking portion 210, and the second locking portion 220 is engaged with the claw 110 of the armature 100, whereby the first portion A may be docked with the second portion B.

Furthermore, the first installation groove portion A10 may include a step G1 formed by recessing an area around the entrance side thereof, and the second installation groove portion B10 may include a protrusion G2 formed to be accommodated on the step G1 of the first installation groove portion A10, stabilizing the position fixation of the first portion A and the second portion B.

The pole portion 230 may be formed to include a space therein, the first locking portion 210 and the second locking portion 220 are disposed from inside to outside, and the armature 100 may be disposed to allow the claw 110 to be inserted into the pole portion 230.

As the first installation groove portion A10, the second installation groove portion B10, and the pole portion 230 are all formed in a circular shape, the pole portion 230 may be formed in a cylindrical shape with an internal space. The first installation groove portion A10, the second installation groove portion B10, and the pole portion 230 may also be formed in an angled shape to minimize looseness when connected.

The first locking portion 210 and the second locking portion 220 may be disposed in the internal space of the pole portion 230, and the claw 110 of the armature 100 may be formed to be inserted into the pole portion 230 and connected to the second locking portion 220.

Accordingly, the first locking portion 210 and the second locking portion 220 may each be disposed in the internal space of the pole portion 230 in a direction toward the outside of the second installation groove portion B10, and the second locking portion 220 may be disposed at the outermost side in the internal space of the pole portion 230, and thus directly connected to the claw 110 of the armature 100.

The second portion B may further include a driving portion 240, and the first locking portion 210 and the second locking portion 220 may be selectively connectable to the armature 100 by the driving portion 240.

The first locking portion 210 and the second locking portion 220 may be selectively connectable and fixed to the armature 100 by the driving portion 240. The present disclosure enables the connection and fixing operations of the first locking portion 210 and the second locking portion 220 to be performed simultaneously by one driving portion 240.

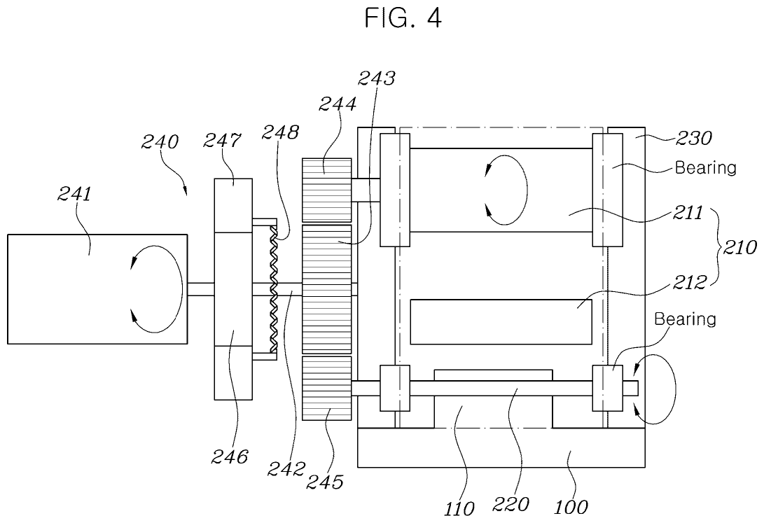

As illustrated in FIG. 4, the driving portion 240 includes a motor portion 241, a driving gear 243, a first driven gear 244, and a second driven gear 245.

The motor portion 241 includes a shaft 242 and generates a rotation force to rotate the shaft 242. The operation of the motor portion 241 may be controlled by a controller.

The driving gear 243 is coupled to the shaft 242 to rotate together with the shaft 242, and the first driven gear 244 and the second driven gear 245 mesh with the driving gear 243 interposed therebetween. The first locking portion 210 is connected to the first driven gear 244, and the second locking portion 220 is connected to the second driven gear 245. Therefore, the first driven gear 244 and the second driven gear 245 may be rotated simultaneously by the rotation force of the motor portion 241, performing a docking operation through the first locking portion 210 and the second locking portion 220.

A detailed structure in which the first locking portion 210 and the second locking portion 220 are fixed to the armature 100 by the driving portion 240 described above will be described below.

As illustrated in FIG. 1, the first locking portion 210 may include a first magnet portion 211 and a second magnet portion 212, wherein the first magnet portion 211 is rotatably disposed in the pole portion 230 and connected to the first driven gear 244, and the second magnet portion 212 is spaced apart from the first magnet portion 211 and is fixed to the pole portion 230.

The first magnet portion 211 and the second magnet portion 212 may be formed of permanent magnets, so that the magnetic polarity of a magnetic field may change depending on the rotation position of the first magnet portion 211.

The fixation of the first locking portion 210 and the armature 100 is achieved using magnetism, and the pole portion 230 may be fixed to the armature 100 through the magnetic flow of the first magnet portion 211 and the second magnet portion 212, which are formed of permanent magnets.

The first magnet portion 211 is connected to the first driven gear 244 and rotated in the pole portion 230, the directions of the N and S poles contacting with the pole portion 230 is reversed. As the second magnet portion 212 is fixed to the pole portion 230, the positions of the N and S poles are fixed.

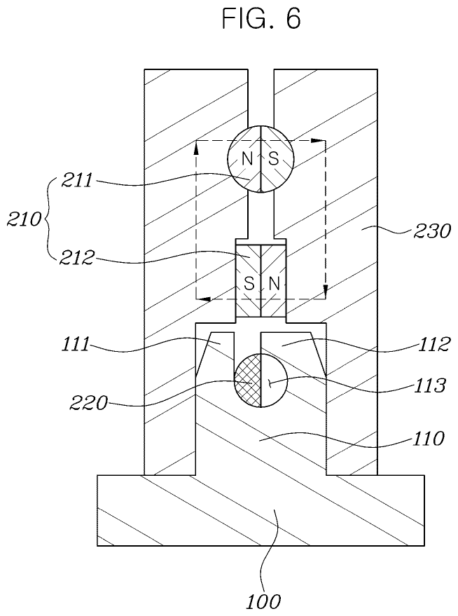

Thus, referring to FIG. 6, when the first magnet portion 211 is rotated so that the polarities of the first magnet portion 211 are positioned to intersect with the polarities of the second magnet portion 212, magnetic flow is formed only in the first magnet portion 211 and the second magnet portion 212 via the pole portion 230. Accordingly, the pole portion 230 may be in an unattached state even when in contact with the armature 100.

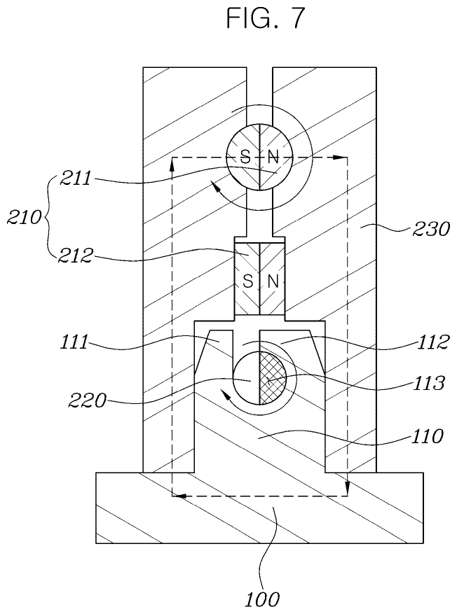

As illustrated in FIG. 7, when the polarities of the first magnet portion 211 matches the polarities of the second magnet portion 212 by rotation of the first magnet portion 211, the direction of magnetic field formation is formed to pass through the armature 100 through the pole portion 230, and thus the pole portion 230 and the armature 100 may be attached to each other by magnetism.

In the present way, the attached state of the pole portion 230 and the armature 100 by magnetic force may be accomplished only by operating the driving portion 240 to change the rotation position of the first magnet portion 211. That is, in an exemplary embodiment of the present disclosure, the attached state of the pole portion 230 and the armature 100 may be switched through the first magnet portion 211 and the second magnet portion 212, and in the state in which the polarity of the first magnet portion 211 are matched with the polarity of the second magnet portion 212, the attached state is maintained even when the driving portion 240 is not driven, and thus the power consumption for maintaining the docking is reduced.

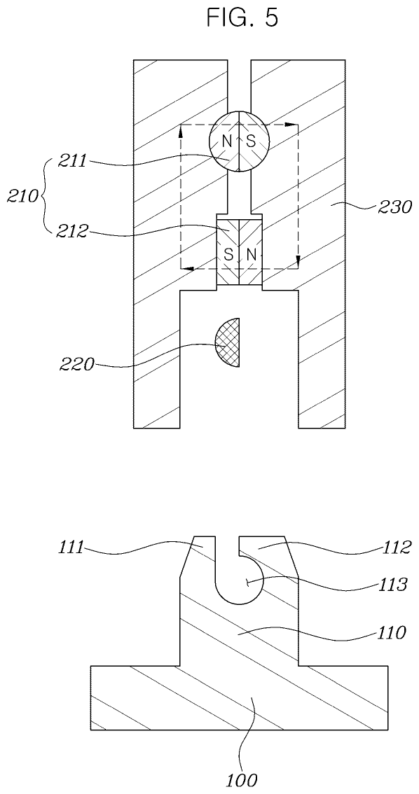

As illustrated in FIG. 5, the second locking portion 220 may include a cross-section formed in a semicircular shape, an insertion groove 113 may be formed between one end portion 111 and the other end portion 112 of the claw 110 of the armature 100, and the other end portion 112 may be bent toward the insertion groove 113.

In the present way, the insertion groove 113 is formed between the one end portion 111 and the other end portion 112 of the claw 110 of the armature 100, and the other end portion 112 is bent toward the entrance of the insertion groove 113. In the instant case, the one end portion 111 and the other end portion 112 are formed to allow the insertion of the semicircular second locking portion 220 at the entrance side, and the insertion groove 113 includes an internal space in which the semicircular second locking portion 220 may be rotated.

Thus, as illustrated in FIG. 5 and FIG. 6, the pole portion 230 is moved toward the armature 100 so that the second locking portion 220 is inserted into the insertion groove 113 of the claw 110, and as illustrated in FIG. 7, as the driving portion 240 is operated, the second locking portion 220 is rotated and engaged with the bent portion of the other end portion 112.

In the present way, according to an exemplary embodiment of the present disclosure, the first locking portion 210 and the second locking portion 220 may be fixed to the armature 100 by operation of the driving portion 240, and the fixation by magnetism of the first locking portion 210 and the fixation by engagement of the second locking portion 220 with the claw 110 may be simultaneously performed, ensuring the docking connection of the first portion A and the second portion B.

A fastening groove A11 may be formed on the internal surface of the first installation groove portion A10 of the first portion A, and the driving portion 240 may further include a moving member 247 which is selectively inserted into the fastening groove A11 by being linearly moved in conjunction with the rotation of the shaft 242.

As illustrated in FIGS. 1 and 4, the fastening groove A11 of the first installation groove portion A10 and the moving member 247 may be formed to mutually match when the pole portion 230 is in contact with the armature 100 and is fixed via the first locking portion 210 and the second locking portion 220.

The moving member 247 is an element of the driving portion 240, and when the shaft 242 is rotated by operation of the motor portion 241, the moving member 247 is inserted into the fastening groove A11 by being linearly moved in conjunction with the rotation of the shaft 242. As a structure in which the moving member 247 is moved linearly by the rotation of the shaft 242, various methods may be applied, including a rack-and-pinion method.

Through the moving member 247, the first locking portion 210 and the second locking portion 220 are fixed to the armature 100 during docking of the first portion A and the second portion B, and the moving member 247 is inserted and fixed in the fastening groove A11 of the first portion A, ensuring the robust maintenance of the docked state between the first portion A and the second portion B.

The driving portion 240 may further include a cam portion 246 which is coupled to the shaft 242 and rotates, and includes a protruding section on a circumferential surface thereof, and the protruding section of the cam portion 246 may be formed to be matched with the moving member 247 when the first locking portion 210 and the second locking portion 220 are connected to the armature 100 by operation of the driving portion 240.

That is, the cam portion 246 is coupled to the shaft 242 and rotates together therewith, and a partial section of the circumferential surface of the cam portion 246 protrudes to form the protruding section, so that when the protruding section is brought into contact with the moving member 247 by rotation of the cam portion 246, the moving member 247 is pushed and moved by the cam portion 246. Thus, the moving member 247 may be linearly moved in conjunction with the rotation of the cam portion 246.

Accordingly, the cam portion 246 may be configured so that when the first locking portion 210 and the second locking portion 220 are not connected to the armature 100, the protruding portion is spaced apart from the moving member 247, and that when the first locking portion 210 and the second locking portion 220 are connected to the armature 100 by operation of the driving portion 240, the protruding portion is brought into contact with the moving member 247, connecting the moving member 247 to the first portion A.

A separate guide structure may be applied to enable the linear movement of the moving member 247 in the second portion B, although this is not shown in the drawings.

A pair of moving members 247 may be provided and spaced apart from each other in the direction of linear movement, and the pair of moving members 247 may be connected to each other via an elastic member 248.

In the present way, the pair of moving members 247 may be provided and disposed on both sides of the cam portion 246 while being spaced apart from each other. Accordingly, a pair of protruding section of the cam portions 246 may also be provided.

The elastic member 248 may be formed of a spring, and may be connected to the pair of moving members 247 to provide a resilient force so that the moving members 247 is moved toward the cam portion 246.

Thus, even though the moving members 247 are moved in conjunction with the rotation of the cam portion 246, the moving members 247 may be returned to the original positions thereof by the elastic member 248 when the moving members 247 deviate from the protruding section of the cam portion 246.

In the present way, the present disclosure ensures docking stabilization during docking of the first portion A and the second portion B by increasing the fastening strength of the first portion A and the second portion B through the connection using the magnetic force of the first locking portion 210, the engagement of the second locking portion 220 with on the claw 110, and the connection in which the moving member 247 is inserted into the fastening groove A11.

A sealing member S may be further provided to seal around the first installation groove portion A10 and the second installation groove portion B10 when connecting the first portion A to the second portion B.

The sealing member S may be formed of a rubber material, and may seal around the first installation groove portion A10 and the second installation groove portion B10 when the first portion A is docked with the second portion B, preventing external foreign matter or moisture from entering the first installation groove portion A10 and the second installation groove portion B10.

Furthermore, because the sealing member S seals around the first installation groove portion A10 and the second installation groove portion B10, noise caused by the driving portion 240 being operated and sound caused by fastening impact may be insulated.

As described above, the docking device according to an exemplary embodiment of the present disclosure enables docking between the first portion A and the second portion B to be performed by the attachment and engagement of the first locking portion 210 and second locking portion 220, provided in the second portion B, to and with the amateur 100, provided in the first portion A, by the driving portion 240. Furthermore, the first locking portion 210 and the second locking portion 220 may be connected to the armature 100, and the moving member 247 provided in the second portion B may be inserted into the fastening groove A11 provided in the first portion A by the driving portion 240, increasing the fastening strength.

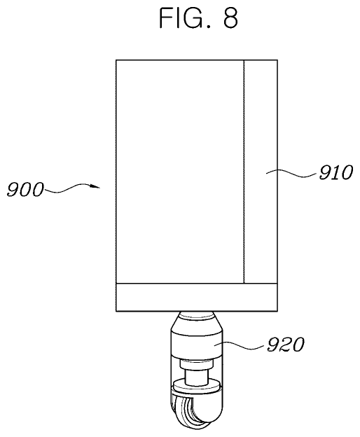

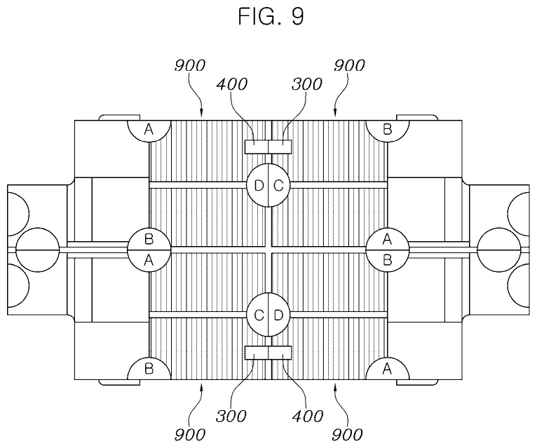

An autonomous mobile device 900 including a docking device according to an exemplary embodiment of the present disclosure includes a body 910 and a driving module 920, as illustrated in FIG. 8 and FIG. 9.

In an exemplary embodiment of the present disclosure, the autonomous mobile device 900 refers to a device which is configured for autonomously determining a movement direction and moving without any manipulation by a user or a passenger. For example, the autonomous mobility device 900 in embodiments may be an autonomous vehicle, an autonomous mobile robot, a robotic space, or a Mobility Pavilion.

The robotic space is a spatial concept in mobility which may be flexibly transformed to suit the purpose and context through a software-based vehicle control system. The present robotic technology may be used to minimize a user's physical effort and time investment, allowing the user to change spaces conveniently and safely. Furthermore, the robotic space is a concept in which the robotic space can provide various experiences within mobility through the variability of content and services via software, can provide various spaces even as a movement means, and may be expanded into a new business platform by increasing the utilization of space even when not moving.

The Mobility Pavilion is a concept which involves reusing and recycling end-of-life mobility to contribute to urban regeneration in infrastructure-deprived areas while also provided as a physical hub for connecting various type of mobility in metropolitan areas. The Mobility Pavilion can break down the boundaries between architecture and mobility, providing various experiences of movement means. That is, the Mobility Pavilion can serve as both mobility and infrastructure, depending on the user, through a structure optimized for assembly and expansion changes through modular design. The Mobility Pavilion is a circular concept where obsolete old mobility modules are repurposed and regenerated into spaces, and is an eco-friendly and efficient future urban infrastructure proposal which can produce both vehicles and spaces within the mobility production line.

In the present way, the autonomous mobile device 900 may be implemented in various ways depending on the intended use, and accordingly, a docking device for interconnecting different autonomous mobile devices 900 is required. The docking device may not only connect the autonomous mobile devices 900 to each other, but may also ensure fastening strength which stably maintains the docked state.

The body 910 is a portion which provides an internal space for use or in which specific devices are provided, and the docking device of the present disclosure may be provided on the body 910.

The driving module 920 is for moving the body 910, and may be variously configured as a motorized wheel, a walking means, etc. The driving module 920 may include elements such as a motor or engine for providing power to a moving means, or a steering device or steering wheel for adjusting the direction of the moving means.

Accordingly, a docking device may be applied to the body 910 of the autonomous mobile device 900 of the present disclosure, and the portion to which the docking device is applied is divided into a first portion A and a second portion B. The first portion A and the second portion B are areas on the body 910 of the autonomous mobile device 900 which may be docked, and the first portion A and the second portion B may be distributed to any one of the autonomous mobile devices 900, or may be applied to all of the autonomous mobile devices 900, enabling various docking position configurations.

In the body 910 of the autonomous mobile device 900, the first portion A includes the armature 100 including a claw 110, and the second portion B includes the first locking portion 210 which is fixed to the armature 100 by forming a magnetic field when contacting with the armature 100, and the second locking portion 220 which is rotatably provided and engaged/connected to the claw 110 by a change in rotation position depending on a rotation angle thereof. Thus, when the different bodies 910 are interconnected, the first portion A and the second portion B may be in a docked state due to the formation of a magnetic field of the first locking portion 210 and the engagement of the second locking portion 220 with the claw 110.

In the present way, the autonomous mobile devices 900 may be connected through the first portion A and the second portion B provided in each body 910, and when the first portion A and the second portion B are connected, the first portion A and the second portion B of different autonomous mobile devices 900 may be connected and docked with each other through the fixation using the formation of a magnetic field in the first locking portion 210 and the physical fixation using the engagement of the second locking portion 220.

Here, referring to FIG. 1, the second portion B may include: the pole portion 230 in which the first locking portion 210 and the second locking portion 220 are provided; and the driving portion (240) configured to selectively connect the first locking portion 210 and the second locking portion 220 to the armature 100. The driving portion 240 may include: the motor portion 241 including the shaft 242 which is rotated by a rotation force; the driving gear 243 coupled to the shaft 242; the first driven gear 244 meshed with the driving gear 243 and connected to the first locking portion 210; and the second driven gear 245 meshed with the driving gear 243 and connected to the second locking portion 220.

The pole portion 230 is fixed to the second portion B, and includes the first locking portion 210 and the second locking portion 220 therein. The first locking portion 210 and the second locking portion 220 may be selectively connectable to the armature 100 by the driving portion 240 when the pole portion 230 is matched with the armature 100.

The driving portion 240 may be controlled by a controller, and the controller may also control the movement of the autonomous mobile device 900.

The driving portion 240 includes the motor portion 241, the driving gear 243, the first driven gear 244, and the second driven gear 245. The motor portion 241 is provided with the shaft 242, and generates a rotation force to rotate the shaft 242. The driving gear 243 is coupled to the shaft 242 and rotates therewith, and the first driven gear 244 and the second driven gear 245 mesh with the driving gear 243 interposed therebetween. The first locking portion 210 is connected to the first driven gear 244 and the second locking portion 220 is connected to the second driven gear 245, so that the first driven gear 244 and the second driven gear 245 may be simultaneously rotated by the rotation force of the motor portion 241, performing the docking operation using the first locking portion 210 and the second locking portion 220.

The first locking portion 210 may include the first magnet portion 211 and the second magnet portion 212, wherein the first magnet portion 211 is rotatably disposed in the pole portion 230 and connected to the first driven gear 244, and the second magnet portion 212 is spaced apart from the first magnet portion 211 and fixed to the pole portion 230.

The first locking portion 210 and the armature 100 may be fixed to each other by use of magnetism, and the pole portion 230 may be fixed to the armature 100 through magnetic flow of the first magnet portion 211 and the second magnet portion 212, which are made of permanent magnets.

That is, as the first magnet portion 211 is connected to the first driven gear 244 and rotated in the pole portion 230, and the second magnet portion 212 is fixed in the pole portion 230, the polarity direction of the first magnet portion 211 is reversed, whereby selective fixation to the armature 100 may be accomplished through the formation of magnetic fields of the first magnet portion 211 and the second magnet portion 212 via the pole portion 230.

The second locking portion 220 may include a cross-section formed in a semicircular shape and the center point of rotation thereof may be connected to the second driven gear 245. The insertion groove 113 may be formed between one end portion 111 and the other end portion 112 of the claw 110 of the armature 100, and the other end portion 112 may be bent toward the insertion groove 113.

Thus, the insertion groove 113 is formed between the one end portion 111 and the other end portion 112 of the claw 110 of the armature 100, and the other end portion 112 is bent toward the entrance of the insertion groove 113. In the instant case, the one end portion 111 and the other end portion 112 are formed so that the semicircular second locking portion 220 may be inserted at the entrance side, and the insertion groove 113 may be formed to include an internal space in which the semicircular second locking portion 220 may be rotated.

Thus, the pole portion 230 may be moved toward the armature 100 so that the second locking portion 220 is inserted into the insertion groove 113 of the claw 110, and when the second locking portion 220 is rotated by operation of the driving portion 240, the second locking portion 220 may be rotated and engaged with/fixed to the bent portion of the other end portion 112.

The strength of the fastening between the first portion A and the second portion B may be increased by adding a fixing structure in which the moving member 247, which is linearly moved in conjunction with the rotation of the shaft 242 of the driving portion 240, is connected to the fastening groove A11 in the first portion A.

As illustrated in FIG. 9, the body 910 may further include an additional portion C and a corresponding portion D for docking at locations different from those of the first portion A and the second portion B.

In each body 910, the additional portion C and the corresponding portion D may be portions different from the first portion A and the second portion B, and the additional portion C and the corresponding portion D may be used to dock different autonomous mobile devices 900 with each other in various directions.

Accordingly, the additional portion C may include the same armature 100′ as the first portion A, and the corresponding portion D may include the same first locking portion 210′ and second locking portion 220′ as the second portion B.

That is, when the additional portion C is connected to the corresponding portion D, the first locking portion 210′ and the second locking portion 220′ may be fixed to an armature 100′ by the formation of a magnetic field in the first locking portion 210′ and the engagement of the second locking portion 220′ with a claw 110′ of the armature 100′, enabling the additional portion C and the corresponding portion D to be docked with each other.

In the present way, multiple autonomous mobile devices 900 may be docked with each other in a state in which the first portion A is matched with the second portion B, and another autonomous mobile device 900 may be further docked by matching an additional portion C with a corresponding portion D.

In the present way, the present disclosure enables multiple different autonomous mobility devices 900 to be docked in various directions, enhancing the utilization of the internal space, such as expanding and re-purposing of the internal space according to the intended use.

In an exemplary embodiment of the present disclosure, when the first portion A and the second portion B of different autonomous mobile devices 900 are docked with each other, and another autonomous mobile device 900 is docked via the additional portion C and the corresponding portion D, docking strength and docking convenience should be secured.

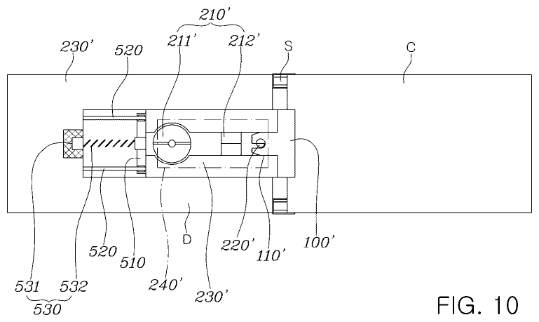

Accordingly, as illustrated in FIG. 10, the additional portion C may include: a pole portion 230′ in which the first locking portion 210′ and the second locking portion 220′ are disposed; and a driving portion 240′ configured to selectively connect the first locking portion 210′ and the second locking portion 220′ to the armature 100′, wherein the pole portion 230′ and the driving portion 240′ are configured to be withdrawable or insertable, so that when the pole portion 230′ and the driving portion 240′ are positioned to be matched with the armature 100′, the pole portion 230′ and the driving portion 240′ may be withdrawn, and then the first locking portion 210′ and the second locking portion 220′ may be fixed to the armature 100′ by the driving portion 240′.

That is, the docking structure of the first locking portion 210′ and the second locking portion 220′ according to the operation of the driving portion 240′ is the same, but the pole portion 230′ and the driving portion 240′ may be configured to be withdrawable from or insertable into the corresponding portion D. To the present end, the corresponding portion D may include: a guide block 510 coupled to the pole portion 230′; a guide pin 520 configured to guide linear movement of the guide block 510; and a driving unit 530 connected to the guide block 510 to move the guide block 510 along the guide pin 520. The drive unit 530 may include a motor 531 and a leadscrew 532.

Thus, the pole portion 230′ and the driving portion 240′ may be withdrawn or inserted depending on whether the driving unit 530 is operated. When different autonomous mobile devices 900 are docked with each other via the additional portion C and the corresponding portion D, each autonomous mobile device 900 may be docked through a process in which the driving portion 240 operates after operation of the driving unit 530.

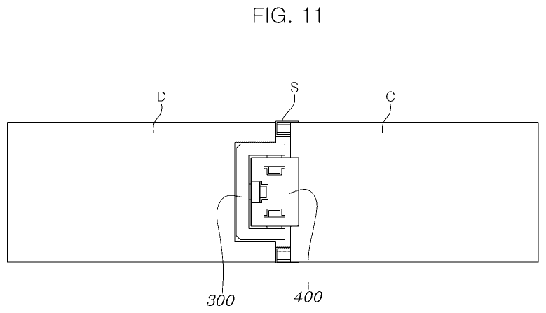

Furthermore, as illustrated in FIG. 11, one of the additional portion C and the corresponding portion D may include a guide rail 300, and the other may include a roller 400 which is inserted into and moved along the guide rail 300.

Thus, when docking different autonomous mobile devices 900, the roller 400 provided on the body 910 of one autonomous mobile device 900 is inserted into the guide rail 300 provided on the body 910 of the other autonomous mobile device 900, facilitating matching between the portions of the autonomous mobile devices 900 that need to be docked with each other. Furthermore, as the roller 400 is inserted into the guide rail 300, tolerance may be absorbed, stabilizing the docking structure between the autonomous mobile devices 900.

In the docking device including the structure as described above and the autonomous mobile device including the same, the docking device for docking the autonomous mobile device maintains a robust docked state by a combination of a magnetic fixation and a physical contact fixation.

Furthermore, looseness is prevented from occurring while the autonomous mobile device is docked, and the contact portions of two portions are sealed to prevent the occurrence of a gap during docking.

Furthermore, the term related to a control device such as “controller”, “control apparatus”, “control unit”, “control device”, “control module”, “control circuit”, or “server”, etc refers to a hardware device including a memory and a processor configured to execute one or more steps interpreted as an algorithm structure. The memory stores algorithm steps, and the processor executes the algorithm steps to perform one or more processes of a method in accordance with various exemplary embodiments of the present disclosure. The control device according to exemplary embodiments of the present disclosure may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors. The processor may include various logic circuits and operation circuits, may be configured for processing data according to a program provided from the memory, and may be configured to generate a control signal according to the processing result.

The control device may be at least one microprocessor operated by a predetermined program which may include a series of commands for carrying out the method included in the aforementioned various exemplary embodiments of the present disclosure.

The aforementioned invention can also be embodied as computer readable codes on a computer readable recording medium. The computer readable recording medium is any data storage device that can store data which may be thereafter read by a computer system and store and execute program instructions which may be thereafter read by a computer system. Examples of the computer readable recording medium include Hard Disk Drive (HDD), solid state disk (SSD), silicon disk drive (SDD), read-only memory (ROM), random-access memory (RAM), CD-ROMs, magnetic tapes, floppy discs, optical data storage devices, etc and implementation as carrier waves (e.g., transmission over the Internet). Examples of the program instruction include machine language code such as those generated by a compiler, as well as high-level language code which may be executed by a computer using an interpreter or the like.

In various exemplary embodiments of the present disclosure, each operation described above may be performed by a control device, and the control device may be configured by multiple control devices, or an integrated single control device.

In various exemplary embodiments of the present disclosure, the memory and the processor may be provided as one chip, or provided as separate chips.

In various exemplary embodiments of the present disclosure, the scope of the present disclosure includes software or machine-executable commands (e.g., an operating system, an application, firmware, a program, etc.) for enabling operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Furthermore, the terms such as “unit”, “module”, etc. included in the specification mean units for processing at least one function or operation, which may be implemented by hardware, software, or a combination thereof.

Hereinafter, the fact that pieces of hardware are coupled operably may include the fact that a direct and/or indirect connection between the pieces of hardware is established by wired and/or wirelessly.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the present specification, unless stated otherwise, a singular expression includes a plural expression unless the context clearly indicates otherwise.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

According to an exemplary embodiment of the present disclosure, components may be combined with each other to be implemented as one, or some components may be omitted.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A docking apparatus comprising:
an armature disposed in a first portion of the docking apparatus and including a claw;
a first locking portion disposed in a second portion of the docking apparatus and fixed to the armature by forming a magnetic field when in contact with the armature; and
a second locking portion rotatably disposed in the second portion and fixed to the claw by a change in rotation position depending on a rotation angle thereof,
wherein when the first portion is connected to the second portion, the first portion is docked with the second portion by the formation of the magnetic field in the first locking portion and engagement of the second locking portion with the claw.

2. The docking apparatus of claim 1, wherein a first installation groove portion including the armature embedded therein is formed in the first portion, a second installation groove portion is formed in the second portion, the second installation groove portion is provided with a pole portion extending to be insertable into the first installation groove portion, and the first locking portion and the second locking portion are provided in the pole portion.

3. The docking apparatus of claim 2, wherein the pole portion includes a space therein, the first locking portion and the second locking portion are disposed from inside to outside, and the armature is disposed to allow the claw to be inserted into the pole portion.

4. The docking apparatus of claim 2, wherein the second portion further includes a driving portion, and the first locking portion and the second locking portion are connected to the armature by the driving portion.

5. The docking apparatus of claim 4, wherein the driving portion includes:
a motor portion including a shaft configured to be rotated by a rotation force;
a driving gear connected to the shaft;
a first driven gear meshed with the driving gear and connected to the first locking portion; and
a second driven gear meshed with the driving gear and connected to the second locking portion.

6. The docking apparatus of claim 5,
wherein the first locking portion includes a first magnet portion and a second magnet portion,
wherein the first magnet portion is rotatably disposed in the pole portion and connected to the first driven gear, and
wherein the second magnet portion is spaced apart from the first magnet portion and fixed to the pole portion.

7. The docking apparatus of claim 6, wherein the first magnet portion and the second magnet portion are formed of permanent magnets, and a magnetic polarity of the magnetic field is changed depending on a rotation position of the first magnet portion.

8. The docking apparatus of claim 5,
wherein the claw includes a first end portion and a second end portion, and
wherein the second locking portion includes a cross-section formed in a semicircular shape, an insertion groove is formed between the first end portion and the second end portion of the claw of the armature, and the second end portion is bent toward the insertion groove.

9. The docking apparatus of claim 5,
wherein a fastening groove is formed on an internal surface of the first installation groove portion in the first portion, and
wherein the driving portion further includes a moving member configured to be selectively inserted into the fastening groove by moving in conjunction with rotation of the shaft.

10. The docking apparatus of claim 9, wherein the driving portion further includes a cam portion including a protruding section on a circumferential surface thereof and connected to the shaft to be rotated, and
wherein the protruding section of the cam portion is configured to be matched with the moving member when the first locking portion and the second locking portion are connected to the armature by operation of the driving portion.

11. The docking apparatus of claim 9,
wherein the moving member is in pair and
wherein the pair of moving members are disposed and spaced apart from each other in a direction of linear movement of the moving members, and the pair of moving members are connected to each other via an elastic member.

12. The docking apparatus of claim 2, wherein a sealing member is further provided to seal around the first installation groove portion and the second installation groove portion when the first portion is connected to the second portion.

13. An autonomous mobile device having a docking apparatus and comprising a body and a driving module,
wherein each body includes a first portion or a second portion for docking,
wherein the first portion includes an armature including a claw, and
wherein the second portion includes a first locking portion fixed to the armature by forming a magnetic field when in contact with the armature, and a second locking portion rotatably disposed and engaged with the claw by a change in rotation position depending on a rotation angle thereof,
whereby when different bodies are connected to each other, the first portion is docked with the second portion by the formation of the magnetic field in the first locking portion and the engagement of the second locking portion with the claw.

14. The autonomous mobile apparatus of claim 13,
wherein the second portion includes:
a pole portion in which the first locking portion and the second locking portion are disposed; and
a driving portion configured to selectively connect the first locking portion and the second locking portion to the armature, and
wherein the driving portion includes:
a motor portion including a shaft configured to be rotated by a rotation force;
a driving gear connected to the shaft;
a first driven gear meshed with the driving gear and connected to the first locking portion; and
a second driven gear meshed with the driving gear and connected to the second locking portion.

15. The autonomous mobile apparatus of claim 14, wherein the first locking portion includes a first magnet portion and a second magnet portion, the first magnet portion is rotatably disposed in the pole portion and connected to the first driven gear, and the second magnet portion is spaced apart from the first magnet portion and fixed to the pole portion.

16. The autonomous mobile apparatus of claim 14,
wherein the second locking portion includes a cross-section formed in a semicircular shape and includes a rotation center point connected to the second driven gear, and
wherein the claw includes a first end portion and a second end portion, and
wherein an insertion groove is formed between the first end portion and the second end portion of the claw of the armature, and the second end portion is bent toward the insertion groove.

17. The autonomous mobile apparatus of claim 14,
wherein the body further includes an additional portion and a corresponding portion for docking at positions different from the first portion and the second portion, the additional portion includes the same armature as the first portion, and the corresponding portion includes the same first locking portion and second locking portion as the second portion, enabling the different bodies to be docked in a direction different from a docking direction of the first portion and the second portion through docking of the additional portion and the corresponding portion.

18. The autonomous mobile apparatus of claim 17,
wherein the additional portion includes:
a pole portion in which the first locking portion and the second locking portion are disposed; and
a driving portion configured to selectively connect the first locking portion and the second locking portion to the armature, and
wherein the pole portion and the driving portion are configured to be withdrawable or insertable, so that when the pole portion and the driving portion are positioned to be matched with the armature, the pole portion and the driving portion are withdrawn, and then the first locking portion and the second locking portion are fixed to the armature by the driving portion.

19. The autonomous mobile apparatus of claim 17, wherein one of the additional portion and the corresponding portion includes a guide rail, and another of the additional portion and the corresponding portion includes a roller configured to be inserted into and moved along the guide rail.
